(19) United States
(12) Patent Application Publication
(10) Pub. No.: US 2025/0273727 A1
(43) Pub. Date: Aug. 28, 2025

(54) METHOD FOR PRODUCING BATTERY, BATTERY, METHOD FOR PRODUCING LAMINATE FILM WITH EDGE INSULATING MEMBER, AND LAMINATE FILM WITH EDGE INSULATING MEMBER

(71) Applicant: TOYOTA JIDOSHA KABUSHIKI KAISHA, Toyota-shi (JP)

(72) Inventor: Kenichi KAKISHITA, Nagoya-shi (JP)

(73) Assignee: TOYOTA JIDOSHA KABUSHIKI KAISHA, Toyota-shi (JP)

(21) Appl. No.: 19/034,915

(22) Filed: Jan. 23, 2025

(30) Foreign Application Priority Data
Feb. 28, 2024 (JP) 2024-028251

(51) Int. Cl. H01M 10/04; H01M 50/197; H01M 50/593

(52) U.S. Cl. CPC H01M 10/0431; H01M 50/197; H01M 50/593

(57) ABSTRACT

The present disclosure provides a method for producing a battery wherein an insulating member can be easily disposed on the edge of a laminate film. The method for producing a battery 10 according to the disclosure comprises the following steps: (a) preparing an electrode stack 110 housed in a laminate film 120, (b) at least partially joining together the laminate film at the perimeter edges of the electrode stack to form a perimeter joint 120a, and (c) disposing an insulating member 130 so as to cover an edge face 120b of the laminate film and at least part of the main side 120c of the laminate film adjacent to the edge face.

### FIELD

The present disclosure relates to a method for producing a battery, to a battery, to a method for producing a laminate film with an edge insulating member, and to a laminate film with an edge insulating member.

### BACKGROUND

Batteries are known which comprise an electrode stack and a laminate film housing the electrode stack. In such a battery, the edges of the members forming the laminate film may need to be protected. When the laminate film has a metal layer, for example, the battery may suffer deterioration upon exposure to moisture and air by exposure of the metal layer. In order to protect the metal layer, techniques have been developed for providing an insulating member at the edges of the laminate film.

PTL 1, for example, discloses a pouch-type secondary battery comprising a battery case made of a laminated sheet (laminate film) and an electrode assembly (electrode stack) housed in the battery case, the battery case comprising an upper case and a lower case each made of a laminated sheet comprising an outer coating layer (protective resin layer), a metal layer and an inner coating layer (sealant resin layer), a sealing part for joining between the upper case and lower case being provided at the outer edges of the upper case and lower case, and a conformal coating layer (insulating member) being formed on the sides of the sealing part in order to prevent exposure of the metal layer.

### CITATION LIST

### Patent Literature

[PTL 1] Japanese Patent Public Inspection No. 2021-510901

### SUMMARY

### Technical Problem

The step of disposing the insulating member on the laminate film still has room for improvement from the viewpoint of productivity.

It is an object of the present disclosure to provide a method for producing a battery wherein an insulating member can be easily disposed on the edge of a laminate film, as well as a battery that can be produced by the method. It is another object of the present disclosure to provide a method for producing a laminate film with an edge insulating member which allows an insulating member to be easily disposed on the edge, and a laminate film with an edge insulating member that can be easily produced by the method.

### Solution to Problem

The present inventors have found that this object can be achieved by the following means.

### <Aspect 1>

A method for producing a battery, comprising the following steps:
(a) preparing an electrode stack housed in a laminate film,
(b) at least partially joining together the laminate film at the perimeter edges of the electrode stack to form a perimeter joint, and
(c) disposing an insulating member so as to cover an edge face of the laminate film and at least part of the main side of the laminate film adjacent to the edge face.

### <Aspect 2>

The method according to aspect 1, wherein a perimeter joint is formed on the edge face of the laminate film in step (b).

### <Aspect 3>

The method according to aspect 1, wherein a perimeter joint is formed on the parts other than the edge face of the laminate film in step (b).

### <Aspect 4>

The method according to aspect 3, wherein the insulating member is disposed in a manner intruding within the laminate film in step (c).

### <Aspect 5>

The method according to any one of aspects 1 to 4, which further comprises a step of cutting the edge of the laminate film, after step (b).

### <Aspect 6>

A battery comprising an electrode stack and a laminate film housing the electrode stack, wherein:
the laminate film has a perimeter joint where it is at least partially joined together at the perimeter edges of the electrode stack, and the insulating member is disposed so as to cover an edge face of the laminate film and at least part of the main side of the laminate film adjacent to the edge face.

### <Aspect 7>

The battery according to aspect 6, wherein the laminate film has a sealant resin layer, a metal layer and a protective resin layer in that order.

### <Aspect 8>

The battery according to aspect 6 or 7, wherein the laminate film is joined together at the edge face.

### <Aspect 9>

The battery according to aspect 6 or 7, wherein the laminate film is not joined together at the edge face.

### <Aspect 10>

The battery according to aspect 9, wherein the insulating member is intruding within the laminate film at the edge face.

### <Aspect 11>

A method for producing a laminate film with an edge insulating member, the method comprising the following step:
disposing an insulating member so as to cover an edge face of the laminate film and at least part of the main side of the laminate film adjacent to the edge face.

### <Aspect 12>

A laminate film with an edge insulating member, wherein the insulating member is disposed so as to cover an edge face and at least part of the main side adjacent to the edge face.

### <Aspect 13>

A battery comprising:
an electrode stack, and
a laminate film with an edge insulating member according to aspect 12, housing the electrode stack.

### Advantageous Effects of Invention

According to the method of the disclosure it is possible to easily produce a battery of the disclosure having an insulating member disposed at an edge of the laminate film. According to the method of the disclosure it is also possible to easily produce a laminate film with an edge insulating member, having an insulating member disposed at an edge.

### BRIEF DESCRIPTION OF DRAWINGS

FIG. 1A is a schematic diagram exemplifying the method of the disclosure for producing a battery.

FIG. 1B is a schematic diagram exemplifying the method of the disclosure for producing a battery.

FIG. 1C is a schematic diagram exemplifying the method of the disclosure for producing a battery.

FIG. 2 is a simplified perspective view showing an example of a battery of the disclosure.

FIG. 3 is a schematic plan view showing an example of a battery of the disclosure.

FIG. 4 is a simplified cross-sectional view showing an example of a method of disposing an insulating member in a battery of the disclosure.

FIG. 5 is a simplified cross-sectional view showing an example of a method of disposing an insulating member in a battery of the disclosure.

FIG. 6 is a simplified cross-sectional view showing an example of a method of disposing an insulating member in a laminate film with an edge insulating member of the disclosure.

FIG. 7 is a simplified cross-sectional view showing an example of a method of disposing an insulating member in a battery comprising a laminate film with an edge insulating member of the disclosure.

### DESCRIPTION OF EMBODIMENTS

An embodiment of the disclosure will now be described in detail with reference to the accompanying drawings. The disclosure is not limited to the embodiment described below, however, and various modifications may be implemented which do not depart from the gist thereof. The dimensional relationships in the drawings do not reflect actual dimensional relationships.

### <<Method for Producing Battery>>

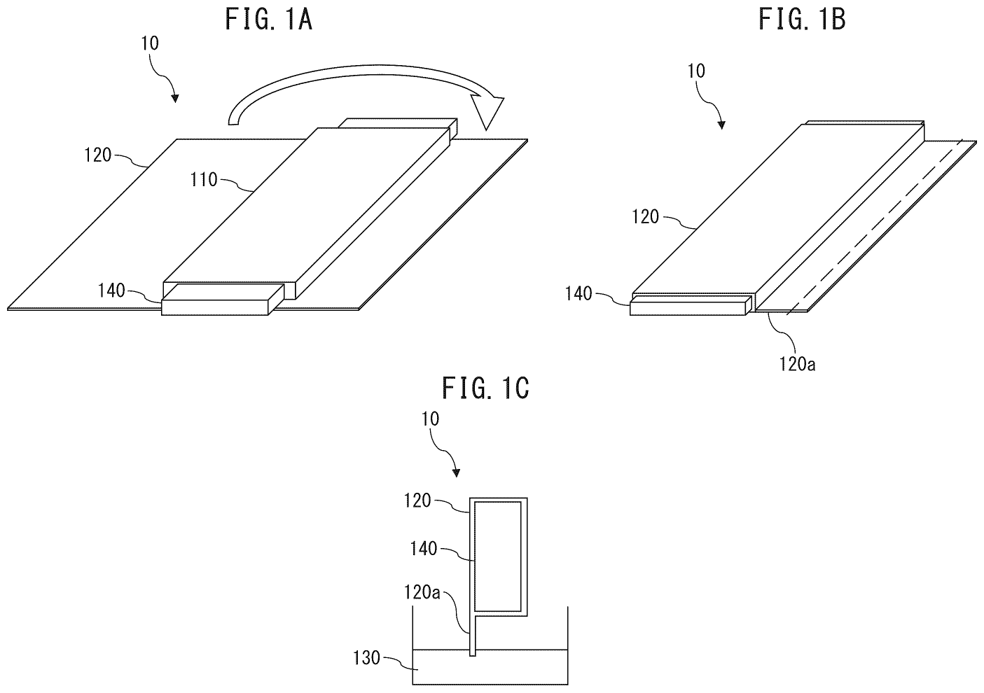

As exemplified in FIG. 1 and FIGS. 4 and 5, the method for producing a battery 10 according to the disclosure comprises the following steps: (a) preparing an electrode stack 110 housed in a laminate film 120, (b) at least partially joining together the laminate film at the perimeter edges of the electrode stack to form a perimeter joint 120a, and (c) disposing an insulating member 130 so as to cover an edge face 120b of the laminate film and at least part of the main side 120c of the laminate film adjacent to the edge face.

The present inventors have found that in this method, it is sufficient for the insulating member to be disposed on the edge face and at least part of the main side adjacent to the edge face of the laminate film situated on the perimeter edge of the electrode stack, after the electrode stack has been housed by the laminate film, making it possible to easily produce a battery having an insulating member disposed on a laminate film.

Incidentally, in a battery comprising an electrode stack and a laminate film housing the electrode stack, the insulating member situated on the edge of the laminate film is preferably resistant to peeling from the laminate film.

In this regard, the present inventors have found that in a laminate film having a perimeter joint where it is at least partially joined together at the perimeter edge of the electrode stack, the insulating member is resistant to peeling from the laminate film if the insulating member is disposed so as to cover the edge face of the laminate film and at least part of the main side of the laminate film adjacent to the edge face. The reason for this is thought to be that when the insulating member is disposed so as to cover the edge face of the laminate film in this way, the contact area between the laminate film and the insulating member increases, causing the resistance to be stronger against external force from directions other than the direction from the electrode stack side of the battery toward the insulating member.

Each step in the method of the disclosure for producing a battery will now be explained.

### <Electrode Stack Preparation Step>

As shown in FIG. 1(a), the method of the disclosure comprises (a) preparing an electrode stack 110 housed in a laminate film 120. The method for housing the electrode stack with the laminate film is not particularly restricted. For example, the method may be wrapping the electrode stack with the laminate film to house it, as shown in FIG. 1(a). Alternatively, a laminate film constructed of first and second films may be used to sandwich and house the electrode stack with the first and second films from above and below in the stacking direction of the electrode stack.

### <Perimeter Joint Forming Step>

As shown in FIG. 1(b), the method of the disclosure comprises (b) at least partially joining together the laminate film at the perimeter edge of the electrode stack to form a perimeter joint 120a. The method for forming the perimeter joint is not particularly restricted, and for example, when the laminate film has a sealant resin layer it may be a method of welding together the sealant resin layer.

The method of the disclosure may form a perimeter joint on the edge face of the laminate film, or it may form a perimeter joint on the parts other than the edge face of the laminate film. In other words, the laminate film may be joined together, or not joined, at the edge face.

The method of the disclosure may also include a step of cutting the edge of the laminate film, after step (b). The cutting location may be the location indicated by the broken line in FIG. 1(b), for example. In this case, the insulating member may be disposed so as to cover the cut surface formed in this manner, as the edge face of the laminate film, in step (c) described below. The laminate film pre-cut to a size that can house the electrode stack may be used to dispose an insulating member covering the cut surface.

### <Insulating Member Disposing Step>

As shown in FIG. 1 (c) and FIGS. 4 and 5, the method of the disclosure comprises (c) disposing an insulating member 130 so as to cover the edge face 120b of the laminate film, and at least part of the main side 120c of the laminate film adjacent to the edge face. FIG. 1 (c) is a schematic diagram showing an example of a method of disposing an insulating member on a laminate film, in a side view from the direction perpendicular to the direction in which the laminate film is wound, where the laminate film is dipped into the insulating member.

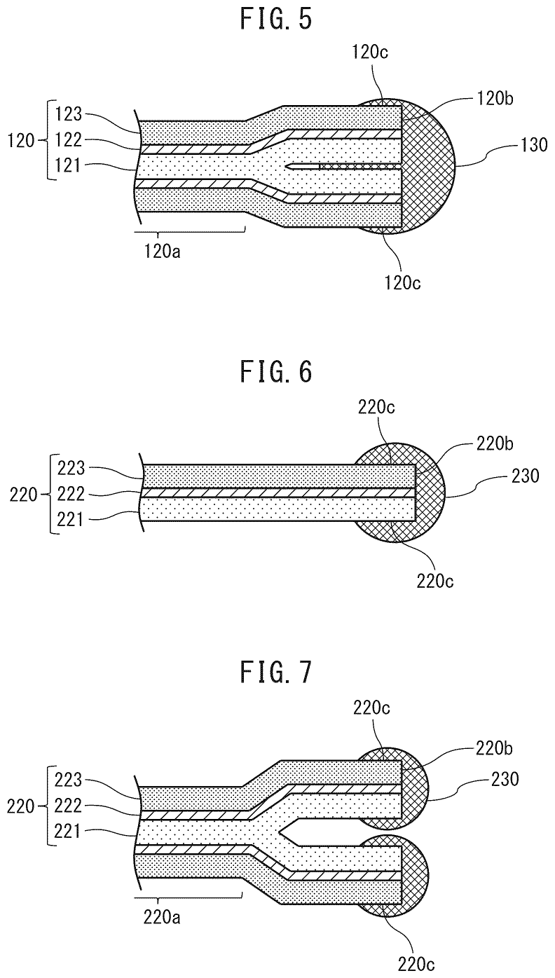

The insulating member 130 may also be disposed in a manner intruding within the laminate film 120 in step (c), as shown in FIG. 5. This method helps the insulating member be resistant to peeling from the laminate film. When the laminate film has a sealant resin layer 121, the insulating member 130 may be disposed in a manner intruding between opposite sealant resin layers 121, as shown in FIG. 5.

The method for disposing the insulating member is not particularly restricted. For example, when the insulating member is a thermoplastic resin, it may be a method of dipping the edge face of the laminate film and at least part of the main side of the laminate film adjacent to the edge face into the molten thermoplastic resin, or a method of coating the molten thermoplastic resin onto the edge face of the laminate film and at least part of the main side of the laminate film adjacent to the edge face.

When the insulating member is a curable resin, for example, it may be a method of dipping the edge face of the laminate film and at least part of the main side of the laminate film adjacent to the edge face into the curable resin and curing it, or a method of coating the curable resin onto the edge face of the laminate film and at least part of the main side of the laminate film adjacent to the edge face, and curing it.

When the insulating member is such a type of resin, the method employed may be one in which the edge face of the laminate film and at least part of the main side of the laminate film adjacent to the edge face is dipped into the resin as shown in FIG. 1 (c), from the viewpoint of productivity, as well as from the viewpoint of helping the insulating member to intrude within the laminate film while the laminate film is not joined together at the edge face.

### <<Battery>>

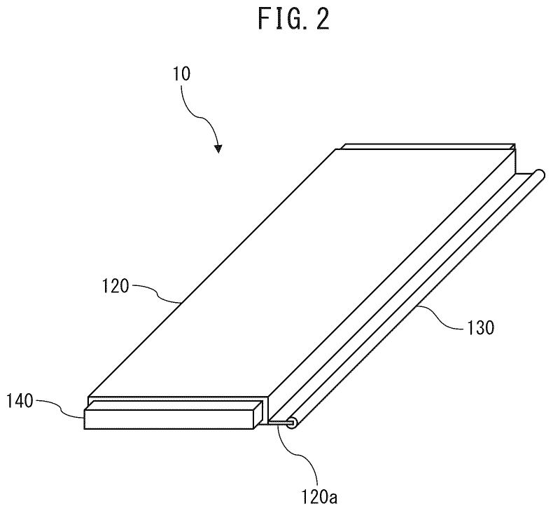

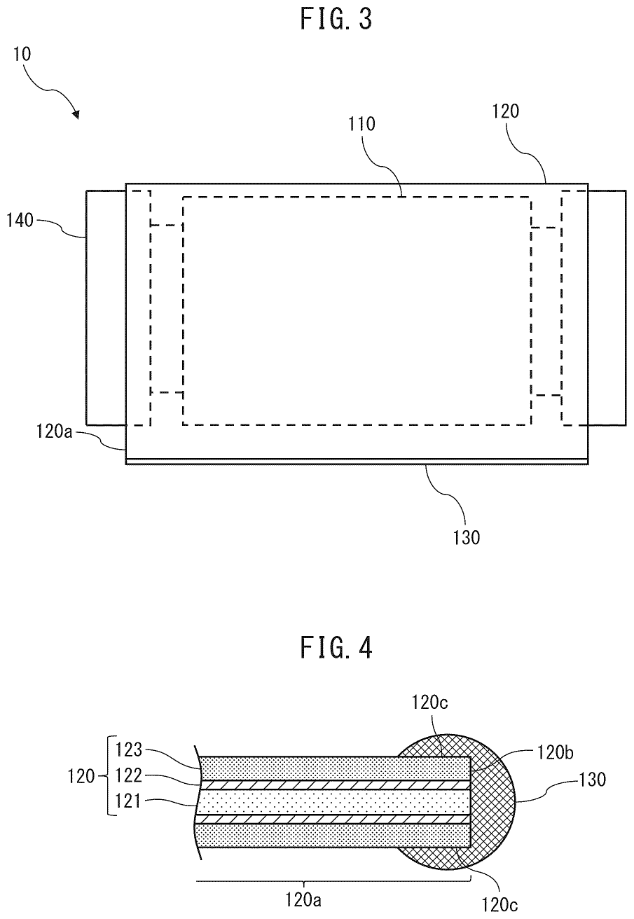

As shown by the example in FIG. 3, the battery 10 of the disclosure comprises an electrode stack 110, and a laminate film 120 housing the electrode stack 110. In the battery 10 of the disclosure, as exemplified in FIGS. 2 to 5, the laminate film 120 has a perimeter joint 120a where it is at least partially joined together at the perimeter edge of the electrode stack 110, and the insulating member 130 is disposed so as to cover the edge face 120b of the laminate film 120 and at least part of the main side 120c of the laminate film 120 adjacent to the edge face 120b.

This battery structure is simple, and the insulating member is resistant to peeling of the laminate film.

The battery may be a lithium ion secondary battery. Examples of battery uses include power sources for vehicles such as hybrid vehicles (HEV), plug-in hybrid vehicles (PHEV), electric vehicles (BEV), gasoline automobiles and diesel automobiles. They are most preferably used as drive power supply units for hybrid vehicles (HEV), plug-in hybrid vehicles (PHEV) or electric vehicles (BEV). The battery of the present disclosure may also be used as a power source for a traveling body other than a vehicle (such as a railway car, ship or aircraft), or as a power source for an electrical product such as an information processing device.

The elements composing the battery of the disclosure will now be described.

### <Electrode Stack>

As shown in FIG. 3, the battery 10 of the disclosure comprises an electrode stack 110. The electrode stack 110 functions as a power generating element in the battery.

The shape of the electrode stack is not particularly restricted, and for example, it may have a top side section, a bottom facing the top side section, and four side sections connecting the top side section and bottom side section. The shape of the top side section is also not particularly restricted, and for example, it may be quadrilateral, such as square, rectangular, rhomboid, trapezoid or parallelogram-shaped. The shape of the top side section may also be a polygonal shape other than quadrilateral, or it may be a shape having curves, such as circular. The shape of the bottom side section may be the same shape as the top side section. The shapes of the side sections are also not particularly restricted, and for example, they may be quadrilateral, such as square, rectangular, rhomboid, trapezoid or parallelogram-shaped.

The electrode stack may have a negative electrode collector layer, negative electrode active material layer, electrolyte layer, positive electrode active material layer and positive electrode collector layer, in that order. The materials of each of the layers are not particularly restricted, and any commonly employed materials for the layers may be used. The thickness of the electrode stack and of the layers forming the electrode stack are not particularly restricted.

### <Laminate Film>

The laminate film 120 houses the electrode stack 110. Specifically, the laminate film may house the electrode stack by winding around the electrode stack. Alternatively, the laminate film may be constructed of first and second films, in which case it may sandwich and house the electrode stack with the first and second films from above and below in the stacking direction of the electrode stack.

As shown in FIGS. 2 to 5, the laminate film 120 in the battery 10 of the disclosure has a perimeter joint 120a at least partially joined together at the perimeter edge of the electrode stack 110. In other words, at least part of the section of the laminate film where the perimeter edge of the electrode stack is present, formed by housing the electrode stack, may be joined together, and therefore the part of the laminate film where the perimeter edge of the electrode stack is present may also have a part that is not joined together. As an alternative, all of the part of the laminate film where the perimeter edge of the electrode stack is present may be joined together.

FIGS. 4 and 5 are magnified simple cross-sectional views of an edge of a laminate film 120 of a battery 10 of the disclosure. As shown in FIGS. 4 and 5, the laminate film 120 may have a sealant resin layer 121, a metal layer 122 and a protective resin layer 123, in that order. In this case the perimeter joint 120a may be formed by welding together the sealant resin layer.

Examples of materials for the sealant resin layer include olefin-based resins such as polypropylene (PP) and polyethylene (PE). Examples of materials for the metal layer include aluminum, aluminum alloy and stainless steel. Examples of materials for the protective resin layer include polyethylene terephthalate (PET) and nylon.

The thicknesses of the layers forming the laminate film and of the laminate film itself are not particularly restricted. The thickness of the sealant resin layer is 40 μm to 100 μm, for example. The thickness of the metal layer is 30 μm to 60 μm, for example. The thickness of the protective resin layer is 20 μm to 60 μm, for example. The thickness of the laminate film is 80 μm to 250 μm, for example.

### <Insulating Member>

As shown in FIGS. 4 and 5, the insulating member 130 in the battery 10 of the disclosure is disposed so as to cover the edge face 120b of the laminate film 120, and at least part of the main side 120c of the laminate film 120 adjacent to the edge face 120b.

When the laminate film 120 has a metal layer 122, the edge face 120b of the laminate film on which the insulating member 130 is disposed may be an edge face where the metal layer 122 is exposed. An example for the edge face 120b is a cut surface formed by cutting the edge of the laminate film 120 at the perimeter edge of the electrode stack 110.

As shown in FIG. 4, the laminate film 120 may be joined together at the edge face 120b. That is, the perimeter joint 120a may be formed at the edge face 120b. In this case, the insulating member 130 may be disposed so as to cover the edge face 120b of the laminate film 120, and at least part of the main side 120c of the laminate film 120 adjacent to the edge face 120b, at the perimeter joint 120a.

Alternatively, the laminate film 120 may not be joined together at the edge face 120b, as shown in FIG. 5. That is, the perimeter joint 120a may be formed at the parts other than the edge face 120b. In this case, the insulating member 130 may intrude within the laminate film 120 at the edge face of the laminate film. When the laminate film has a sealant resin layer, the insulating member 130 may intrude between opposite sealant resin layers 121. That is, the insulating member may be disposed between sealant resin layer and sealant resin layer. This construction helps the insulating member 130 to be further resistant to peeling from the laminate film 120.

The insulating member 130 is not particularly restricted and may be a resin such as a thermoplastic resin or curable resin. From the viewpoint of productivity, the insulating member is most especially a thermoplastic resin.

The thermoplastic resin is not particularly restricted and may be either a non-reactive type or reactive type. A non-reactive type thermoplastic resin is not particularly restricted, and examples include ethylene-vinyl acetate (EVA)-based, synthetic rubber, olefin-based, polyamide-based or polyester-based (such as polyethylene terephthalate (PET)) resins. A reactive type resin is also not particularly restricted, and examples include urethane-based resins.

A curable resin is not particularly restricted, and examples include thermosetting resins or photocuring resins. Such resins may be acrylic or epoxy resins, for example.

### <Collector Terminals>

The battery of the disclosure may comprise collector terminals 140. The collector terminals may each be electrically connected to a current collector of the electrode stack. The materials of the collector terminals are not particularly restricted so long as they have a current collection function. As shown in FIGS. 2 and 3, the collector terminals may be disposed on a pair of opposite side sections of the electrode stack.

The shapes and sizes of the collector terminals are not particularly restricted.

When the battery of the disclosure has collector terminals, the laminate film may house the electrode stack together with the collector terminals. Specifically, the laminate film may house the electrode stack together with the collector terminals by winding together the electrode stack and the collector terminals. The laminate film may also be constructed of first and second films, in which case the first and second films may sandwich the electrode stack and collector terminals from above and below in the stacking direction of the electrode stack, housing the electrode stack together with the collector terminals.

<<Method for Producing Laminate Film with Edge Insulating Member>>

The method of the disclosure for producing a laminate film with an edge insulating member 220 also comprises disposing an insulating member 230 so as to cover the edge face of the laminate film 220b and at least part of the main side of the laminate film 220c adjacent to the edge face.

The present inventors have found that this method can help facilitate production of a laminate film having an insulating member disposed on the edge.

The method for disposing the insulating member may be understood by referring to the aforementioned method for producing a battery according to the disclosure. For example, when a method of disposing the laminate film by dipping in an insulating member is to be employed, the laminate film may be dipped into the insulating member in the manner shown in FIG. 1(c).

<<Laminate Film with Edge Insulating Member>>

As shown in FIG. 6, the insulating member 230 in the laminate film with an edge insulating member 220 of the disclosure is disposed so as to cover the edge face 220b, and at least part of the main side 220c adjacent to the edge face 220b.

This facilitates production of the laminate film with an edge insulating member and helps prevent peeling of the insulating member from the laminate film.

The laminate film with an edge insulating member 220 may have a sealant resin layer 221, a metal layer 222 and a protective resin layer 223, in that order.

The edge face of the laminate film with an edge insulating member of the disclosure may be a cut surface where the laminate film has been cut beforehand according to the size and shape of the electrode stack, so that the electrode stack can be housed and the part of the laminate film where the perimeter edge of the electrode stack is present can be reduced.

The battery may also have the electrode stack housed by the laminate film with an edge insulating member. That is, the battery 20 may comprise an electrode stack 210, and a laminate film with an edge insulating member 220 according to the disclosure, housing the electrode stack 210. The laminate film with an edge insulating member 220 may also have a perimeter joint 220a which is at least partially joined together at the perimeter edge of the electrode stack 210. The laminate film with an edge insulating member 220 of the disclosure may be understood by referring to the aforementioned description of the laminate film with an edge insulating member of the disclosure.

By thus using a laminate film with an edge insulating member having an insulating member already disposed at a desired location, it is possible to easily produce a battery that is resistant to peeling of the insulating member from the laminate film, as shown in FIG. 7. FIG. 7 is a magnified simple cross-sectional view of an edge of a laminate film with an edge insulating member 220 of a battery 20 of the disclosure.

The constituent elements of the battery will be understood by referring to the aforementioned description of the battery of the disclosure.

### REFERENCE SIGNS LIST

10, 20 Battery
110, 210 Electrode stack
120 Laminate film
220 Laminate film with edge insulating member
120a, 220a Perimeter joint
120b, 220b Edge face
120c, 220c Main side
121, 221 Sealant resin layer
122, 222 Metal layer
123, 223 Protective resin layer
130, 230 Insulating member
140 Collector terminal

1. A method for producing a battery, comprising the following steps:
(a) preparing an electrode stack housed in a laminate film,
(b) at least partially joining together the laminate film at the perimeter edges of the electrode stack to form a perimeter joint, and
(c) disposing an insulating member so as to cover an edge face of the laminate film and at least part of the main side of the laminate film adjacent to the edge face.

2. The method according to claim 1, wherein a perimeter joint is formed on the edge face of the laminate film in step (b).

3. The method according to claim 1, wherein a perimeter joint is formed on the parts other than the edge face of the laminate film in step (b).

4. The method according to claim 3, wherein the insulating member is disposed in a manner intruding within the laminate film in step (c).

5. The method according to claim 1, which further comprises a step of cutting the edge of the laminate film, after step (b).

6. A battery comprising an electrode stack and a laminate film housing the electrode stack, wherein:
the laminate film has a perimeter joint where it is at least partially joined together at the perimeter edges of the electrode stack, and
the insulating member is disposed so as to cover an edge face of the laminate film and at least part of the main side of the laminate film adjacent to the edge face.

7. The battery according to claim 6, wherein the laminate film has a sealant resin layer, a metal layer and a protective resin layer in that order.

8. The battery according to claim 6, wherein the laminate film is joined together at the edge face.

9. The battery according to claim 6, wherein the laminate film is not joined together at the edge face.

10. The battery according to claim 9, wherein the insulating member is intruding within the laminate film at the edge face.

11. A method for producing a laminate film with an edge insulating member, the method comprising the following step:
disposing an insulating member so as to cover an edge face of the laminate film and at least part of the main side of the laminate film adjacent to the edge face.

12. A laminate film with an edge insulating member, wherein the insulating member is disposed so as to cover an edge face and at least part of the main side adjacent to the edge face.

13. A battery comprising:
an electrode stack, and
a laminate film with an edge insulating member according to claim 12, housing the electrode stack.
